(19) United States
(12) Patent Application Publication
(10) Pub. No.: US 2005/0012461 A1
(43) Pub. Date: Jan. 20, 2005

(54) Magnetron

(75) Inventor: Sung-Chol Yang, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/807,344

(22) Filed: Mar. 24, 2004

(30) Foreign Application Priority Data
Jul. 15, 2003 (KR) 2003-48248

(51) Int. Cl. H01J 25/50

(52) U.S. Cl. 315/39.51

(57) ABSTRACT

A magnetron capable of being efficiently assembled is provided. The magnetron includes a filament, a pair of shields, a pair of leads, a pair of connection plates, and a pair of terminal rods. The filament is coil-shaped. The shields are attached to both ends of the filament, respectively. The leads are attached to the shields at first ends of the leads, respectively. The connection plates are attached to second ends of the leads, respectively. The terminal rods are attached to the connection plates, respectively, to supply power to the leads through the connection plates, and have slender protrusions, which have sectional areas smaller than sectional areas of attachment portions of the terminal rods so that the terminal rods are attached to the connection plates with the slender protrusions passing through the connection plates.

### CROSS-REFERENCE TO RELATED APPLICATIONS

This application claims the benefit of Korean Patent Application No. 2003-48248, filed on Jul. 15, 2003 in the Korean Intellectual Property Office, the disclosures of which are incorporated herein by reference.

### BACKGROUND OF THE INVENTION

1. Field of the Invention

The present invention relates, in general, to magnetrons to generate high-frequency waves, and more particularly, to a magnetron that is capable of being assembled efficiently.

2. Description of the Related Art

In general, a magnetron is a device which generates microwaves in various high-frequency heating apparatuses, such as a microwave oven, to heat food, etc.

A conventional magnetron includes a filament supplied with power to produce thermions, first and second shields mounted on both ends of the filament, respectively, to prevent the thermions from moving toward the ends of the filament, a first lead attached to the first shield and positioned to pass through the filament and the second shield, and a second lead attached to the second shield.

The first and second leads are designed to be supplied with external power through a pair of terminal rods that are connected with an external power source. Connection plates are disposed between the first and second leads and the terminal rods to allow the first and second leads and the terminal rods to be electrically connected to each other, respectively.

In the magnetron, the lengths of the terminal rods must be uniformly maintained to cause the terminal rods to come into contact with external power terminals. Accordingly, the terminal rods must be attached to the connection plates with the lengths of the terminal rods adjusted uniformly, therefore making it difficult to assemble the magnetron.

### SUMMARY OF THE INVENTION

Accordingly, it is an aspect of the present invention to provide a magnetron that allows terminal rods to be easily connected to connection plates.

Additional aspects and/or advantages of the invention will be set forth in part in the description which follows and, in part, will be obvious from the description, or may be learned by practice of the invention.

The foregoing and/or other aspects of the present invention are achieved by providing a magnetron, comprising a coil-shaped filament, a pair of shields attached to both ends of the filament, respectively, a pair of leads attached to the pair of shields at first ends of the leads, respectively, a pair of connection plates attached to second ends of the leads, respectively, and a pair of terminal rods attached to the connection plates, respectively, to supply power to the leads through the pair of connection plates, wherein the terminal rods comprises an attachment portion which is attached to each of the connection plates respectively and slender protrusions which have sectional areas smaller than sectional areas of the attachment portions of each of the terminal rods, wherein the pair of terminal rods are attached to the pair of connection plates with the slender protrusions passing through the pair of connection plates.

The slender protrusions and the attachment portions of the terminal rods are circular shaped, and the pair of connection plates are provided with terminal mounting holes having diameters corresponding to diameters of the slender protrusions to allow the slender protrusions to pass therethrough so that the attachment portions of the terminal rods are attached to bottom surfaces of the pair of connection plates and outer surfaces of the slender protrusions of the pair of terminal rods are attached to walls of the terminal mounting holes.

The pair of shields comprising a first shield mounted at a first end of the filament, and a second shield mounted at a second end of the filament, the pair of leads comprising a first lead attached to the first shield and extended through the second shield, and a second lead attached to the second shield, and the pair of connection plates comprising a first connection plate attached to the first lead on a first side of the first connection plate and attached to a first terminal rod on a second side of the first connection plate, and a second connection plate attached to the second lead on a first side of the second connection plate and attached to a second terminal rod on a second side of the second connection plate.

The first and second connection plates are arcuately shaped and provided with terminal mounting holes on first sides of the first and second connection plates, respectively, and are provided with lead mounting holes on second sides of the first and second connection plates, respectively, to allow the leads to be attached thereto.

The first and second terminal rods are attached to the first and second connection plates by a brazing method.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a sectional view of a magnetron, according to the present invention;

FIG. 2 is a partially exploded perspective view of the magnetron of FIG. 1; and

FIG. 3 is an enlarged view of portion III of FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

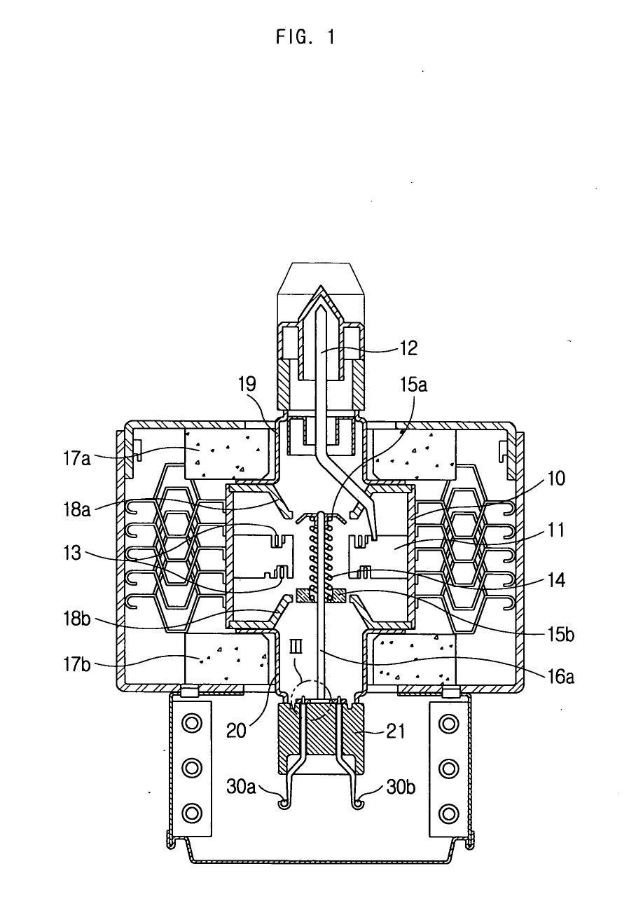

A magnetron of the present invention, as shown in FIG. 1, comprising an anode having a plurality of vanes 11 and an anode cylinder 10 and radially arranged at regular intervals to form resonant circuits, an antenna 12 connected to one of the vanes 11 to introduce harmonics into an outside of the magnetron, and a plurality of strip rings 13 arranged to alternately connect the vanes 11 to each other at tops and bottoms of the vanes 11, respectively.

A cathode comprising a coil-shaped filament 14 to emit thermions at high temperatures is positioned at a center of the anode cylinder 10. A first shield 15a and a second shield 15b are attached to ends of the filament 14, respectively. A first lead 16a is attached to a center of the first shield 15a to pass through a center of the second shield 15b and a central portion of the filament 14. A second lead 16b is attached to a bottom of the second shield 15b. These two leads 16a and 16b are connected with external power terminals 30a and 30b, which allows a closed circuit to be formed in the magnetron so as to produce an electric field.

A first permanent magnet 17a and a second permanent magnet 17b are provided on a top and bottom of the anode, respectively, with opposite magnetic poles of the first and second permanent magnets 17a and 17b facing each other so as to form a magnetic field across the magnetron. A first pole piece 18a and a second pole piece 18b are provided to guide magnetic flux generated by the permanent magnets 17a and 17b toward the filament 14.

A first shield cup 19 and a second shield cup 20 are provided on the first and second pole pieces 18a and 18b to close openings of the first and second pole pieces 18a and 18b and maintain vacuum inside the first and second pole pieces 18a and 18b.

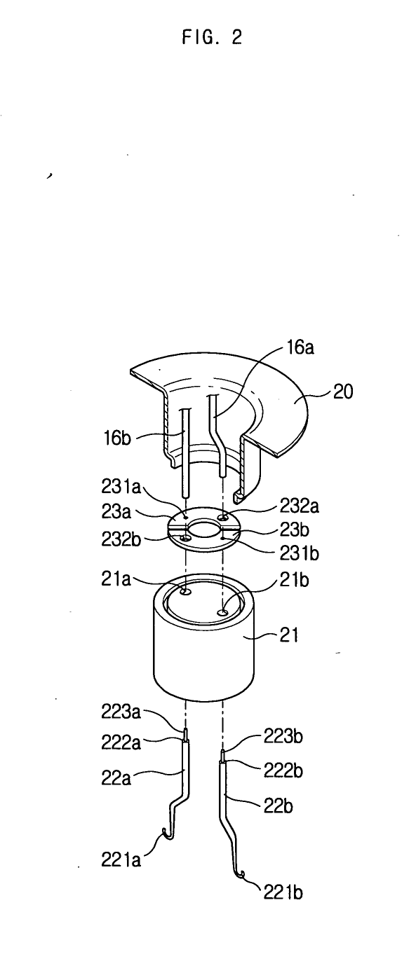

Therefore, the second shield cup 20, as shown in FIG. 2, is open at a bottom thereof to be supplied with power from an outside of the magnetron. An isolation block 21 is positioned to close a lower opening of the second shield cup 20. A pair of terminal rods 22a and 22b are connected to the external power terminals 30a and 30b at first ends of the terminal rods 22a and 22b, respectively, and positioned to pass through the isolation block 21, thus allowing the first and second leads 16a and 16b to be connected to the terminal rods 22a and 22b, respectively.

The isolation block 21 is fabricated by shaping insulation material, such as ceramic, into a cylindrical form. The isolation block 21 is tightly attached to the second shield cup 20 to close the opening of the second shield cup 20, and therefore prevent vibrations from leaking through the second shield cup 20. The isolation block 21 is provided with a pair of through holes 21a and 21b to receive the terminal rods 22a and 22b, respectively.

The terminal rods 22a and 22b include a first terminal rod 22a attached to the first lead 16a and a second terminal rod 22b attached to the second lead 16b. Each of the terminal rod 22a and 22b is provided with a connection portion 221a and 221b, respectively, which are bent in hook forms to be connected to each external power terminals 30a and 30b, at a first end of the terminal rod 22a and 22b, respectively. Each of the terminal rods 22a and 22b is further provided with an attachment portion 222a and 222b which is attached to each connection plate 23a and 23b. Slender protrusions 223a and 223b are protruded from first ends of the attachment portions 222a and 222b to be more slender than the attachment portions 222a and 222b, and therefore have sectional areas smaller than those of the attachment portions 222a and 222b. The attachment portions 222a and 222b and slender protrusions 223a and 223b of the terminal rods 22a and 22b are formed to each have a circular sectional shape so that a diameter of each of the slender protrusions 223a and 223b is smaller than that of each of the attachment portions 222a and 222b.

The connection plates 23a and 23b are formed of metallic plates having arcuate shapes. The connection plates 23a and 23b are provided with terminal mounting holes 231a and 231b, which have shapes and areas corresponding to shapes and areas of the slender protrusions 223a and 223b of the terminal rods 22a and 22b, respectively, on first sides of the connection plates 23a and 23b, respectively. The connection plates 23a and 23b are provided with lead mounting holes 232a and 232b on second sides of the connection plates 23a and 23b to allow the leads 16a and 16b to be attached thereto.

As a result, when the terminal rods 22a an 22b are inserted into the terminal mounting holes 231a and 231b of the connection plates 23a and 23b to attach the terminal rods 22a and 22b to the connection plates 23a and 23b, ends of the attachment portions 222a and 222b of the terminal rods 22a and 22b are positioned underneath the terminal mounting holes 231a and 231b and only the slender protrusions 223a and 223b are inserted into the terminal mounting holes 231a an 231b, so that lengths of portions of the terminal rods 22a and 22b, which are protruded from the second shield cup 20, can be uniformly maintained.

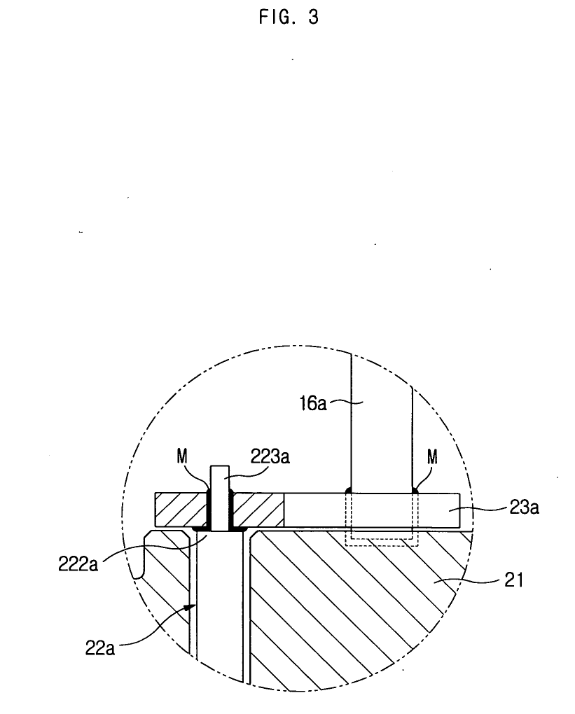

In the present embodiment, the terminal rods 22a and 22b are attached to the connection plates 23a and 23b by a brazing method, as illustrated in FIG. 3. In more detail, a molten alloy M is infiltrated into gaps between the terminal rods 22a and 22b and the connection plates 23a and 23b according to a capillary phenomenon and solidified in these gaps, thus allowing the terminal rods 22a and 22b to be attached to the connection plates 23a and 23b.

Although in the present embodiment, the attachment portions 222a and 222b and slender protrusions 223a and 223b of the terminal rods 22a and 22b have been described as being formed to have circular sections, they are not limited to these but can be formed to have variously shaped sections.

An assembly and operation of the magnetron according to the present invention will be described below.

When the attachment portions 222a and 222b of the terminal rods 22a and 22b are inserted into the terminal mounting holes 231a and 231b of the connection plates 23a and 23b to attach the terminal rods 22a and 22b to the connection plates 23a and 23b, the slender protrusions 223a and 223b formed to have diameters corresponding to diameters of the terminal mounting holes 231a and 231b are passed through the terminal mounting holes 231a and 231b, while the attachment portions 222a and 222b of the terminal rods 22a and 22b formed to have diameters larger than the diameters of the slender protrusions 223a and 223b are caught by the connection plates 23a and 23b underneath the terminal mounting holes 231a and 231b. Accordingly, the terminal rods 22a and 22b are prevented from being deeply inserted into an interior of the second shield 15b, so the lengths of the protruded portions of the terminal rods 22a ad 22b can be uniformly maintained.

When the molten alloy M is applied to the gaps between the connection plates 23a and 23b and the terminal rods 22a and 22b after only the slender protrusions 223a and 223b have been inserted into the terminal mounting holes 231a and 231b, the molten alloy M is infiltrated into the gaps between outer surfaces of the slender protrusions 223a and the 223b and walls of the terminal mounting holes 231a and 231b and between the attachment portions 222a and 222b and bottom surfaces of the connection plates 23a and 23b, and the molten alloy M is cooled and solidified, thus attaching the terminal rods 22a and 22b to the connection plates 23a and 23b.

As apparent from the above description, the present invention provides a magnetron, in which terminal rods are provided with slender protrusions and only the slender protrusions of the terminal rods are inserted into terminal mounting holes of connection plates, thus uniformly maintaining lengths of portions of the terminal rods that are protruded from a second shield cup.

Furthermore, in the magnetron of the present invention, outer surfaces of the slender protrusions of the terminal rods are not only attached to walls of the terminal mounting holes but attachment portions of the terminal rods are also attached to bottom surfaces of the connection plates, so that the terminal rods are securely attached to the connection plates, thus being capable of reliably preventing vacuum leakage.

Although a few of the present invention have been shown and described, it would be appreciated by those skilled in the art that changes may be made in this embodiment without departing from the principles and spirit of the invention, the scope of which is defined in the claims and their equivalents.

1. A magnetron, comprising:
a filament which produces thermions in the magnetron;
a pair of shields attached to ends of the filament which prevent the thermions from moving toward the ends of the filament;
a pair of leads attached to the shields at first ends of the leads, respectively;
a pair of connection plates attached to second ends of the leads, respectively; and
a pair of terminal rods attached to the pair of connection plates, respectively, to supply power to the pair of leads through the connection plates wherein the pair of terminal rods comprises:
an attachment portion which is attached to each connection plate respectively, and slender protrusions which have sectional areas smaller than sectional areas of the attachment portions of the terminal rods so that the pair of terminal rods are attached to the pair of connection plates with the slender protrusions passing through the connection plates.

2. The magnetron of claim 1, wherein:
the slender protrusions and the attachment portions of the pair of terminal rods are circular shaped; and
the connection plates are provided with terminal mounting holes having diameters corresponding to diameters of the slender protrusions to allow the slender protrusions to pass therethrough so that the attachment portions of the pair of terminal rods are attached to bottom surfaces of the connection plates and outer surfaces of the slender protrusions of the pair of terminal rods are attached to walls of the terminal mounting holes.

3. The magnetron of claim 2, wherein the pair of shields comprising:
a first shield mounted at a first end of the filament, and
a second shield mounted at a second end of the filament; and
the pair of leads comprising:
a first lead attached to the first shield and extended through the second shield, and a second lead attached to the second shield; and
the pair of connection plates comprising:
a first connection plate attached to the first lead on a first side of the first connection plate and attached to a first terminal rod on a second side of the first connection plate, and
a second connection plate attached to the second lead on a first side of the second connection plate and attached to a second terminal rod on a second side of the second connection plate.

4. The magnetron of claim 3, wherein the first and second connection plates are arcuately shaped and provided with terminal mounting holes on first sides of the first and second connection plates, respectively, and lead mounting holes on second sides of the connection plates to allow the first and second leads to be attached thereto, respectively.

5. The magnetron of claim 1, wherein the pair of terminal rods are attached to the pair of connection plates by performing a brazing method.

6. A magnetron, comprising:
an anode having a plurality of vanes and an anode cylinder, wherein the plurality of vanes are radially arranged at regular intervals;
an antenna connected to one of the plurality of vanes;
strip rings arranged to alternately connect the plurality of vanes to each other at a top and bottom of the plurality of vanes;
a cathode having a coil-shaped filament to emit thermions at a high temperature and positioned at a center of the anode cylinder;
a first shield and a second shield attached to ends of the coil-shaped filament;
a first lead attached to a center of the first shield to pass through a center of the second shield and a central portion of the filament; and
a second lead attached to a bottom of the second shield, wherein the first and second leads are connected with external power terminals which allows a closed circuit to be formed in the magnetron;
a pair of terminal rods having slender protrusions and connected to the external power terminals at first ends of the terminal rods, respectively and positioned to pass through an isolation block to allow the first and second leads to be connected to each of the terminal rods, respectively; and
a pair of connection plates attached to second ends of the first and second leads, respectively.

7. The magnetron of claim 6, further comprising attachment portions on each of the terminal rods, wherein the attachment portions are attached to bottom surfaces of the pair of connection plates, respectively and the slender protrusions of the terminal rods are attached to terminal mounting holes provided on each of the connection plates, respectively, so that the pair of terminal rods are securely attached to the pair connection plates.

8. The magnetron of claim 6, further comprising a first and a second permanent magnet provided at a top and bottom of the anode, respectively, with opposite magnetic poles of the first and second permanent magnets facing each other so as to form a magnetic field across the magnetron.

9. The magnetron of claim 8, wherein a first pole piece and a second pole piece are provided to guide magnetic flux generated by the first and second permanent magnets toward the filament.

10. The magnetron of claim 9, further comprising a first shield cup and a second shield cup provided on the first and second pole pieces to close openings of the first and second pole pieces and maintain vacuum inside the first and second poles pieces.

11. The magnetron of claim 10, wherein the second shield cup is open at a bottom thereof to be supplied with power from an outside of the magnetron.

12. The magnetron of claim 11, further comprising an isolation block having a pair of through holes to receive the terminal rods and positioned to close a lower opening of the second shield cup.

13. The magnetron of claim 12, wherein the pair terminal rods are connected to the external power terminals at first ends of each of the terminal rods, respectively and positioned to pass through the isolation block allowing the first and second leads to be connected to each of the terminal rods.

14. The magnetron of claim 12, wherein the isolation block is fabricated by shaping insulation material into a cylindrical form.

15. The magnetron of claim 12, wherein the isolation block is tightly attached to the second shield cup to close an opening of the second shield cup and prevent vibrations from leaking through the second shield cup.

16. The magnetron of claim 6, wherein the pair of connection plates are formed of metallic plates having an arcuate shape.

17. The magnetron of claim 6, wherein the pair of connection plates are provided with terminal mounting holes which have shapes and sectional areas corresponding to shapes and sectional areas of the slender protrusions of the pair of terminal rods, and
lead mounting holes on second sides of each of the connection plates to allow the first and second leads to be attached thereto.

18. The magnetron of claim 17, wherein the pair of terminal rods are inserted into the terminal mounting holes of each of the connection plates to attach the terminal rods to the connection plates.

19. The magnetron of claim 17, wherein ends of the attachment portions of the terminal rods are positioned underneath the terminal mounting holes and only the slender protrusions of the terminal rods are inserted into the terminal mounting holes, so that the lengths of portions of the terminal rods which are protruding form the second shield cup can be uniformly maintained.

20. The magnetron of claim 19, wherein the attachment portions of the pair of terminal rods are inserted into the terminal mounting holes of the pair of connection plates to attach the terminal rods to the connection plates.

21. The magnetron of claim 19, wherein the slender protrusions are formed to have diameters corresponding to diameters of the terminal mounting holes and pass through the terminal mounting holes, and
the attachment portions of the terminal rods are formed to have diameters larger than the diameters of the slender protrusions and are caught by the pair of connection plates underneath the terminal mounting holes to prevent the pair of terminal rods from being inserted into an interior of the second shield so that the lengths of the protruded portions of the terminal rods can be uniformly maintained.

22. The magnetron of claim 19, wherein when the slender protrusions are inserted into the terminal mounting holes, a molten alloy is applied to gaps between the pair of connection plates and the pair of terminal rods to attach the pair of terminal rods to the pair of connection plates.
